(19) United States
(12) Patent Application Publication
(10) Pub. No.: US 2012/0021243 A1
(43) Pub. Date: Jan. 26, 2012

(54) COMPONENTS WITH BONDED EDGES

(75) Inventors: Nicholas Joseph KRAY, Mason, OH (US); Joshua Leigh MILLER, West Chester, OH (US); Tod Winton DAVIS, Liberty Township, OH (US); Peter Christopher SCHUMACHER, Morrow, OH (US); John Robert KELLEY, Loveland, OH (US)

(73) Assignee: GENERAL ELECTRIC COMPANY, Schenectady, NY (US)

(21) Appl. No.: 13/182,500

(22) Filed: Jul. 14, 2011

Related U.S. Application Data
(60) Provisional application No. 61/367,099, filed on Jul. 23, 2010.

(51) Int. Cl. B32B 3/00; B23K 31/02

(52) U.S. Cl. 428/602; 228/155

(57) ABSTRACT

A metallic sheath for a mounting on a component is disclosed. The metallic sheath comprises a nose portion extending in a chordwise direction, a first side-wall extending in the chordwise direction from the nose portion and a second side-wall extending in the chordwise direction from the nose portion wherein the second side-wall is bonded to the nose portion such that the nose portion, the first side-wall and the second side-wall form a cavity capable of receiving a portion of the component.

### CROSS-REFERENCE TO RELATED APPLICATION

This application claims priority to U.S. Provisional Application Ser. No. 61/367,099, filed Jul. 23, 2010.

### BACKGROUND OF THE INVENTION

The technology described herein relates generally to gas turbine engines, and more particularly, to components having bonded metallic edges used in gas turbine engines and a method of manufacturing such components.

At least some known gas turbine engines typically include an inlet, a fan assembly, low and high pressure compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as producing useful work to propel an aircraft in flight or to power a load, such as an electrical generator.

Some known fan assemblies include a plurality of blades coupled to a fan rotor wherein such blades may be subject to events that facilitate at least partial fan blade damage at some edges. Many known fan assemblies are designed with a sufficient margin and constructed with sufficient additional load-carrying capabilities to withstand such conditions and reduce a potential for damage in blade breakage events. One method of developing additional load-carrying capability is by using metallic sheaths on composite components. For example, in some applications, airfoil Metal Leading Edges (MLE's) are used to protect and enhance load-carrying capability and prevent erosion in composite airfoils. However due to the complex geometry of the composite components, the metallic sheaths have complex geometries and introduce difficulties in their manufacture. For example, in some applications, complex blade airfoil shapes and load requirements require complex airfoil leading edge wraps (MLE's) having a solid nose shape and side-walls. Such complex metallic sheaths increase the cost of construction of the fan assemblies and can potentially decrease engine fuel efficiency due to the increased weight of the fan assemblies.

At least some known metallic sheaths used on composite structures such as fan blades having complex machined shapes are made from bar stock, hot creep-formed and machined and result in high cost of manufacture. It is desirable to have metallic sheaths having complex three-dimensional geometries that can be made from parts that are made separately and bonded together. It is desirable to have a metallic sheath having an internal cavity with high aspect ratio that is easier to manufacture and easier to assemble with composite components.

### BRIEF DESCRIPTION OF THE INVENTION

In one aspect, a metallic sheath for a mounting on a component comprises a nose portion extending in a chordwise direction, a first side-wall extending in the chordwise direction from the nose portion and a second side-wall extending in the chordwise direction from the nose portion wherein the second side-wall is bonded to the nose portion such that the nose portion, the first side-wall and the second side-wall form a cavity capable of receiving a portion of the component.

In another aspect, a blade assembly is provided. The blade assembly includes an airfoil and a metallic sheath coupled to at least a portion of the airfoil. In a further aspect, a gas turbine engine is provided. The engine includes a rotor and a casing at least partially extending about the rotor. The engine also includes at least one blade assembly coupled to the rotor. The at least one blade assembly includes an airfoil and a metallic sheath coupled to at least a portion of the airfoil.

In another aspect, a method of manufacturing an article comprises the steps of: pre-machining and hot-forming a first part of a metallic sheath; pre-machining and hot-forming second part of the metallic sheath; preparing a first bond surface on the first part; preparing a second bond surface on the second part; diffusion bonding the first part and second part of the metallic sheath at the first and second bond surfaces; and machining a nose portion of the metallic sheath.

### BRIEF DESCRIPTION OF THE DRAWINGS

FIG. 1 is a schematic view of an exemplary gas turbine engine;

FIG. 2 is a schematic view of an exemplary fan blade assembly having a metallic sheath according to an exemplary embodiment that may be used with the gas turbine engine shown in FIG. 1;

FIG. 3 is a schematic view of an exemplary metal leading edge (MLE) according to an exemplary embodiment that may be used with the fan blade assembly shown in FIG. 2;

FIG. 4 is a schematic cross sectional view of a metal leading edge (MLE) according to an exemplary embodiment shown in FIG. 3; and

FIG. 5 is a schematic cross sectional view of two parts of the leading edge portion of an exemplary metal leading edge (MLE) according to an exemplary embodiment before bonding between the two parts.

FIG. 6 is a schematic cross sectional view of the two parts of the leading edge portion of an exemplary metal leading edge (MLE) shown in FIG. 5 after bonding between the two parts.

FIG. 7 is a schematic cross sectional view of three parts of the leading edge portion of another exemplary metal leading edge (MLE) according to an alternative embodiment before bonding the three parts.

FIG. 8 is a schematic cross sectional view of three parts of the leading edge portion of another exemplary metal leading edge (MLE) according to another alternative embodiment before bonding the three parts.

FIG. 9 is a schematic flow chart showing exemplary steps of a manufacturing method to make metallic sheaths.

### DETAILED DESCRIPTION OF THE INVENTION

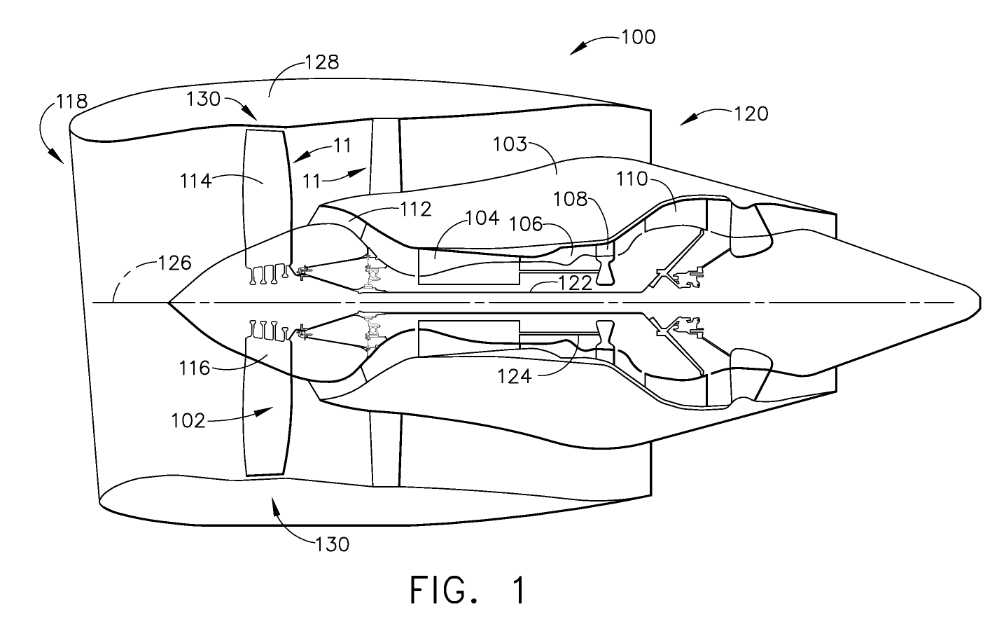

FIG. 1 is a schematic view of an exemplary gas turbine engine 100 including a fan 102 and a core engine 103 including a high pressure compressor 104, and a combustor 106. Engine 100 also includes a high pressure turbine 108, a low pressure turbine 110, and a booster 112. Fan 102 includes an array of fan blade assemblies 114 extending radially outward from a rotor disc 116. Engine 100 has an intake side 118 and an exhaust side 120. Fan 102 and turbine 110 are coupled together using a first rotor shaft 122, and compressor 104 and turbine 108 are coupled together using a second rotor shaft 124. In some applications, such as, for example, shown in FIG. 1, the Fan blade assemblies 114 are at least partially positioned within an engine casing 128. In other applications, the fan blade assemblies 114 may form a portion of an “open rotor”.

During operation, air flows axially through fan 102, in a direction that is substantially parallel to a central axis 126 extending through engine 100, and compressed air is supplied to high pressure compressor 104. The highly compressed air is delivered to combustor 106. Hot gases (not shown in FIG. 1) from combustor 106 drive turbines 108 and 110. Turbine 110 drives fan 102 by way of shaft 122 and similarly, turbine 108 drives compressor 104 by way of shaft 124. Fan blade assemblies 114 rotate within casing 128 such that a substantially annular clearance 130 is formed.

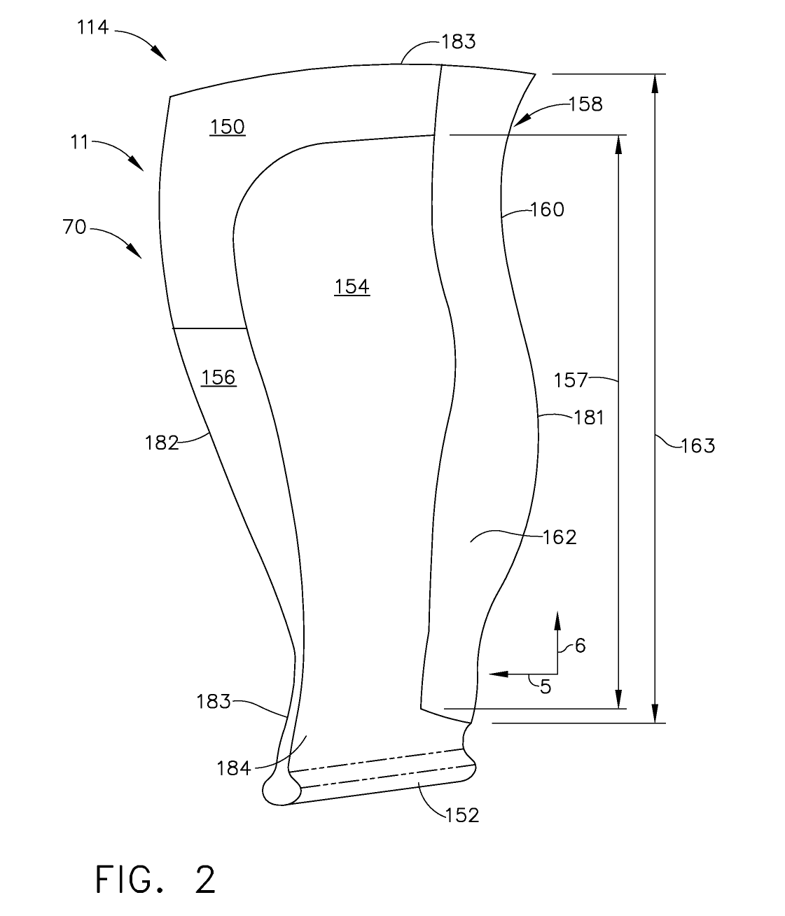

FIG. 2 is a schematic view of exemplary fan blade assembly 114 that may be used with engine 100 (shown in FIG. 1). Each of fan blade assemblies 114 include at least one metallic sheath, such as, for example, a blade tip cap 150 that cooperates with an innermost surface (not shown) of casing 128 to form clearance 130 (both shown in FIG. 1) therebetween. In the exemplary embodiment, tip cap 150 is formed from titanium sheet metal. Alternatively, cap 150 is formed from any material that facilitates operation of assembly 114 as described herein. Blade assembly 114 also includes a dovetail root portion 152 that facilitates coupling assemblies 114 to rotor disc 116 as is known in the art. Blade Assembly 114 further includes an airfoil 154 that is formed from materials via processes that are both known in the art. Such materials include, but are not limited to, composites. In some applications, Blade Assembly 114 may also include a trailing edge guard 156. In the exemplary embodiment shown in FIG. 2, guard 156 is formed from titanium sheet metal. Alternatively, guard 156 is formed from any suitable material that facilitates operation of assembly 114 in the engine 100. Airfoil 154 has a first radial length 157.

Blade Assembly 114 includes a metallic sheath 158, alternatively referred to herein as a metal leading edge (MLE) 158. 1VILE 158 is formed from any metallic material that facilitates operation of fan 102 as described herein, including, but not being limited to, titanium alloys and inconel alloys. Specifically, MLE 158 includes a predetermined tangential stiffness that is discussed further below. MLE 158, as well as cap 150 and guard 156, are coupled to airfoil 154 via methods known in the art, wherein such methods include, but are not limited to, brazing, welding, and adhesive bonding. MLE 158 includes a solid nose region 160 and a plurality of sidewalls 162 (only one facing sidewall 162 shown in FIG. 2). MLE 158 extends along substantially all of airfoil radial length 157. Moreover, a radially innermost portion of MLE 158 extends radially inward to root portion 152 and a radially outermost portion of MLE 158 extends radially outward such that MLE 158 is substantially flush with cap 150. Therefore, in the exemplary embodiment, MLE 158 is configured with a second radial length 163 that is greater than first radial length 157. Alternatively, length 163 is any value that facilitates operation of assembly 114 in the engine 100.

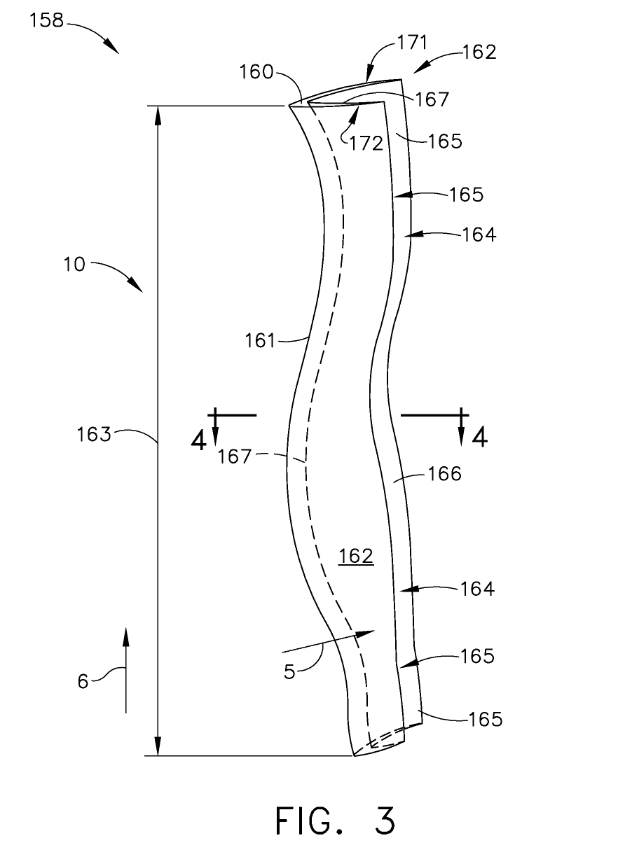

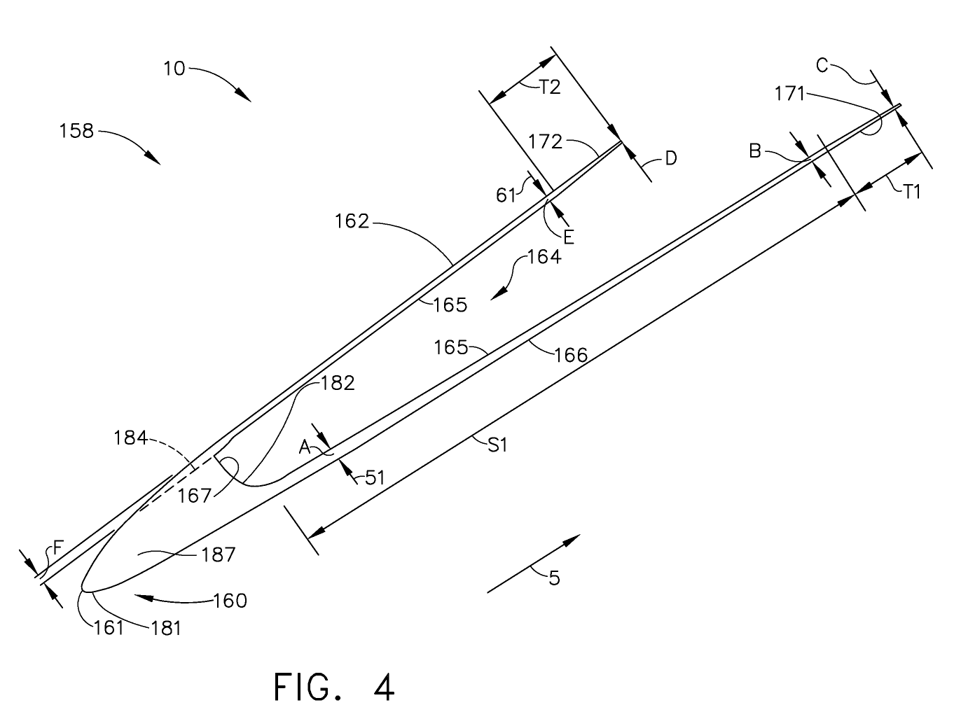

FIG. 3 is a schematic view of an exemplary metal leading edge (MLE) 158 that may be used with fan blade assembly 114 (shown in FIG. 2). FIG. 3 illustrates a slightly skewed perspective of MLE 158 for clarity. Solid nose region 160 is configured with an external apex 161 and a second radial length 163 as described above. Sidewalls 162 are configured with a predetermined of a thickness distribution that is determined as discussed further below. In the exemplary embodiment shown herein, Sidewalls 162, 166 may also be configured with taper regions 171, 172 having predetermined taper in thickness (see FIG. 4 for example) located on an inner surface 165 of sidewalls 162. The taper facilitates substantially smoothing a stress profile (not shown) along the entire periphery of the airfoil-to-MLE interface (not shown). Sidewalls inner surfaces 165 and solid nose portion 160 forms an internal apex 167, MLE 158 also includes a cavity 164 that is formed by inner surfaces 165 and apex 167. Cavity 164 facilitates coupling MLE 158 to airfoil 154 by facilitating conforming MLE 158 to the configuration of airfoil 154. Therefore, cavity 164 varies with variations in the taper of inner surfaces 165, radial length 163, the contours of apex 167 and the contours of airfoil 154.

MLE 158 is configured with a predetermined tangential stiffness such that it can meet and withstand a continuous inrush of air pulled into engine 100 via intake side 118 (both shown in FIG. 1). Such tangential stiffness may also be sufficient to withstand collisions with solid foreign objects inadvertently pulled into engine 100 and high speed contact with casing 128 (shown in FIG. 1). The tangential stiffness of MLE 158 may be varied by changing a length of solid nose region 160 in a radial and/or chordwise direction. Moreover, the tangential stiffness of MLE 158 may be varied by changing the thickness of sidewalls 162, 166 as a function of radial length 163 and along the chordwise direction of the airfoil 154. For example, decreasing the radial length of solid nose region 160 away from radial length 163 decreases the tangential stiffness of MLE 158. Moreover, decreasing the thickness of sidewalls 162, 166 decreases the tangential stiffness of MLE 158. Therefore, altering the radial and/or chordwise length of solid nose region 160 and the thickness of sidewalls 162 as a function of radial length 163 and/or chordwise length alters the tangential stiffness of MLE 158.

FIG. 3 shows an exemplary metallic sheath 10 according to an exemplary embodiment that may be used with the fan blade assembly shown in FIG. 2. The embodiment shown in FIG. 3 is a metal leading edge (MLE) for mounting on a component, such as, for example, on the leading edge 181 portion of a fan blade airfoil 154 shown in FIG. 2. FIG. 4 is a cross sectional view of a metal leading edge (MLE) according to the exemplary embodiment of the present invention shown in FIG. 3.

The exemplary embodiment of the metallic sheath 10 shown in FIGS. 3 and 4 comprises a nose portion 160 extending in a chordwise direction 5 (see FIG. 4). The nose portion has a first contour 181 that defines the outer geometric contour of the MLE. This contour is suitably designed using known methods based on aerodynamic performance and mechanical strength requirements of the component 158 such as a fan blade or other structure. In the cross sectional view shown in FIG. 4, the first contour 161 has an external apex 161. The nose portion 160 has a second contour 182 on the internal portion of the nose portion 160 and as an internal apex 167 located at a chord-wise distance from the external apex 161. The internal contour of the nose portion 160, such as item 182, is suitably designed using known methods to facilitate mounting to a component 11, such as for example, a fan blade shown in FIG. 2 or a static structure, such as a vane shown in FIG. 1.

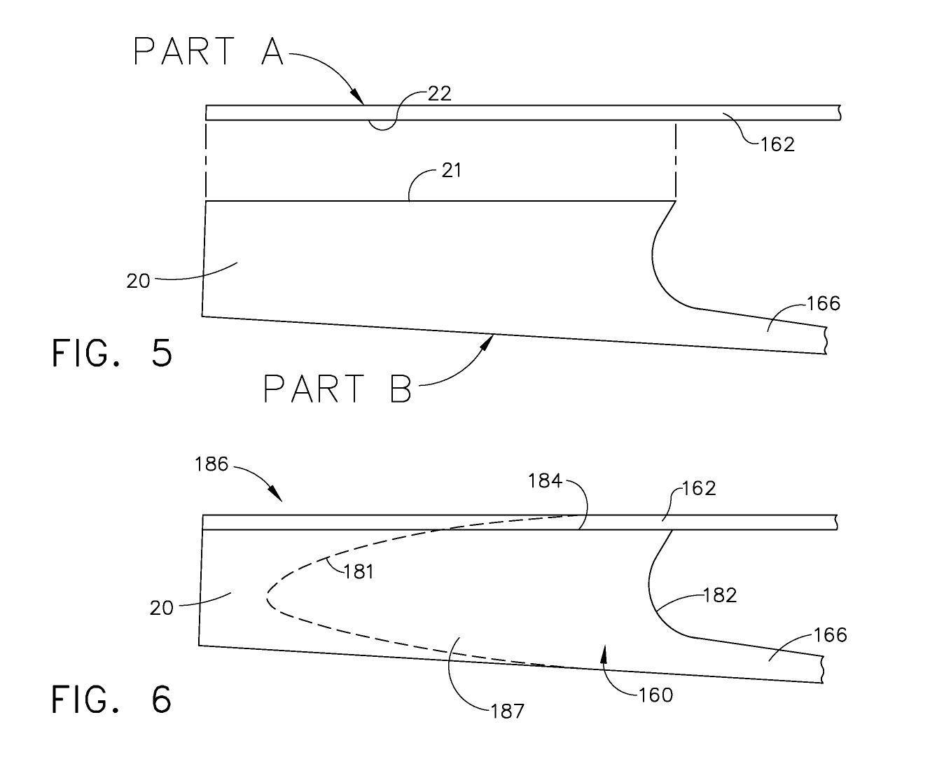

The exemplary metallic sheath 10 shown in FIG. 4 has a first side-wall 166 and a second side-wall 162, both side-walls extending in the chord-wise direction 5 from the nose portion 160. In the preferred embodiment shown in FIG. 4, the second side-wall 162 is bonded using a suitable method to the nose portion 160, forming bond surface 184 between the second side-wall 162 and the nose portion 160. The metallic sheath 10 is constructed such that the nose portion 160, the first side-wall 166 and the second side-wall 162 form a cavity 164 that is capable of receiving a portion of the component. In the exemplary embodiments shown in FIG. 4-6, the nose portion 160 and the first side-wall 166 are formed unitarily using known methods such as machining and/or hot forming, and the second side-wall 162 is bonded to the nose portion 160. FIG. 5 shows a view of the nose portion 160 and the second side-wall 162 just prior to bonding. In one aspect of the present invention, the second side-wall is bonded to the nose portion using diffusion bonding. In the exemplary embodiment shown in FIG. 5, the nose-block 20 and the first side-wall 166 are formed unitarily using known methods. The nose block 20 has a first bonding surface 21. The second side-wall 162, made separately using known manufacturing methods, has a corresponding second bonding surface 22. The first bonding surface 21 and the second bonding surface 22 are brought together and bonded using suitable methods, as described further below. FIG. 5 shows the nose block 20, and its integral first-side wall 166, (Part B) and the second side-wall 162 (Part A) prior to bonding between them. FIG. 6 shows the nose block 20 (and integral first-side wall 166) and the second side-wall 162 after bonding has been established between them to form a bond assembly 186. The bond surface is shown as item 184 in FIG. 6. Further manufacturing operations are performed on the bond assembly 186 to form the sheath 10 (MLE 158, for example). For example, in the bond assembly 186, the nose portion 160 and a portion of the bonded second side-wall 162 are machined to form a MLE 158. FIG. 6 shows, in broken line, the MLE 158 nose 187 first contour 181 that is made using conventional known machining methods. In the exemplary embodiments shown in FIGS. 4-6, the second bonding surface 22 on the second side-wall 162 is bonded to the first bonding surface 21 on the nose block 20 prior to machining of the bond assembly 186. Alternatively, in other embodiments, the second side-wall 162 may be unitarily manufactured with a nose block and the first-side wall 166 may be bonded with the nose block. In one aspect of the present invention, bonding of the side-walls in the bond assembly is done using diffusion bonding.

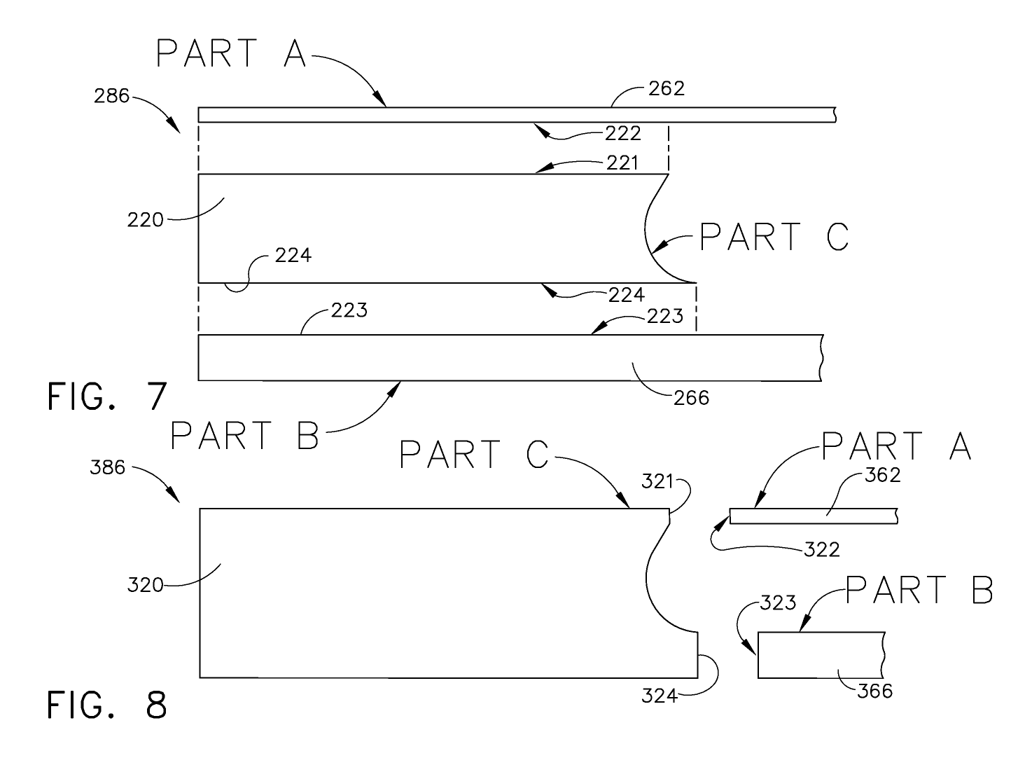

In alternative embodiments, such as, for example, shown in FIGS. 7 and 8, both the first side-wall 266, 366 and the second side-wall 262, 362 may be bonded to the nose block 220, 320. Known bonding methods can be used. In the exemplary alternative embodiment shown in FIG. 7, a third bonding surface 223 on a lateral side of the first side-wall 266 is bonded to a fourth bonding surface 224 on a lateral side of the nose block 220. As shown in FIG. 7, both the first-side wall 266 and the second side-wall 262 are bonded to the lateral sides of a nose block 220 to form a bond assembly 286. The nose portion 160 of the MLE is subsequently machined from the bond assembly 286. FIG. 8 shows another alternative embodiment, wherein the both the first-side wall 366 and the second side-wall 362 are bonded to the edges of a nose block 320 to form a bond assembly 386. In one aspect of the present invention, bonding of the side-walls in the bond assembly is done using diffusion bonding. The nose portion 160 of the MLE is subsequently machined from the bond assembly 386 using known methods.

In one aspect, the metallic sheath 10 may have variable thicknesses in the chord-wise direction 5, such as for example shown in FIG. 4. The exemplary MLE 158 shown in FIG. 5 has a first side-wall 166 wherein the thickness 51 “A” of at least a portion of the first side-wall 166 tapers in the chordwise direction to a lower thickness “B”. Although FIG. 5 shows the second side-wall 162 having a constant thickness 61 “E”, in alternative embodiments, the second side-wall 162 may have a variable thickness as suitable for a particular application. In other embodiments the thickness 61 of a portion of the second side-wall 162 may taper in the chordwise direction. In another aspect of the embodiment shown in FIG. 4, the first side-wall 166 has a first taper region 171 wherein the thickness of the first side-wall reduces from “B” to “C” at the chord-wise end of the first side-wall, and the second side-wall 162 has a first taper region 172 wherein the thickness of the second side-wall reduces from “E” to “D” at the chord-wise end of the second side-wall. In a preferred embodiment, the first and second side-walls 166, 162 may have thickness between about 0.020 to 0.050 inches and the first and second taper regions may have a length (T1, T2 in FIG. 4) of about 0.5 inches, having a thickness of about 0.010 inch at the chord-wise end (see “C” and “D” in FIG. 4). These first and second taper regions facilitate bonding of the MLE 158 to the composite article, such as a blade assembly 114 (see FIG. 2). Further, the thicknesses of the metallic sheath 10 (such as the MLE 158) may also vary in a span-wise direction 6 (see FIG. 2) as necessary for particular applications.

In one embodiment, FIG. 2 shows a composite article 70, such as a composite fan blade assembly 114, comprising a composite structure 154 having at least one edge (such as item 181) and a metallic sheath 10 bonded to a portion of the composite structure 154. The metallic sheath has a first side-wall 166 and a second side-wall 162 extending in a chordwise direction 5 from a nose portion 160, as shown in FIG. 2. As described previously herein, in one embodiment, the second side-wall is bonded to the nose portion such that the nose portion, the first side-wall and the second side-wall form a cavity 164 that receives a portion of the composite structure 154. In the embodiment shown in FIG. 2, the composite structure 154 is an airfoil having a pressure side 183, a suction side 184, a leading edge 181 and a trailing edge 182 and wherein the airfoil extends in a span-wise direction 6. In the exemplary embodiment shown in FIG. 2, another metallic sheath 10 (a trailing edge guard, item 156) is located near at least a portion of the trailing edge 181 of the composite article 158. Also shown in the exemplary embodiment shown in FIG. 2, another metallic sheath 10 (a blade tip cap, item 150) is located near a tip 183 of the airfoil located at the span-wise end of the composite article 158. The tip cap 150 and the trailing edge guard 156 may be manufactured as described previously herein for the MLE, using diffusion bonding and machining as needed.

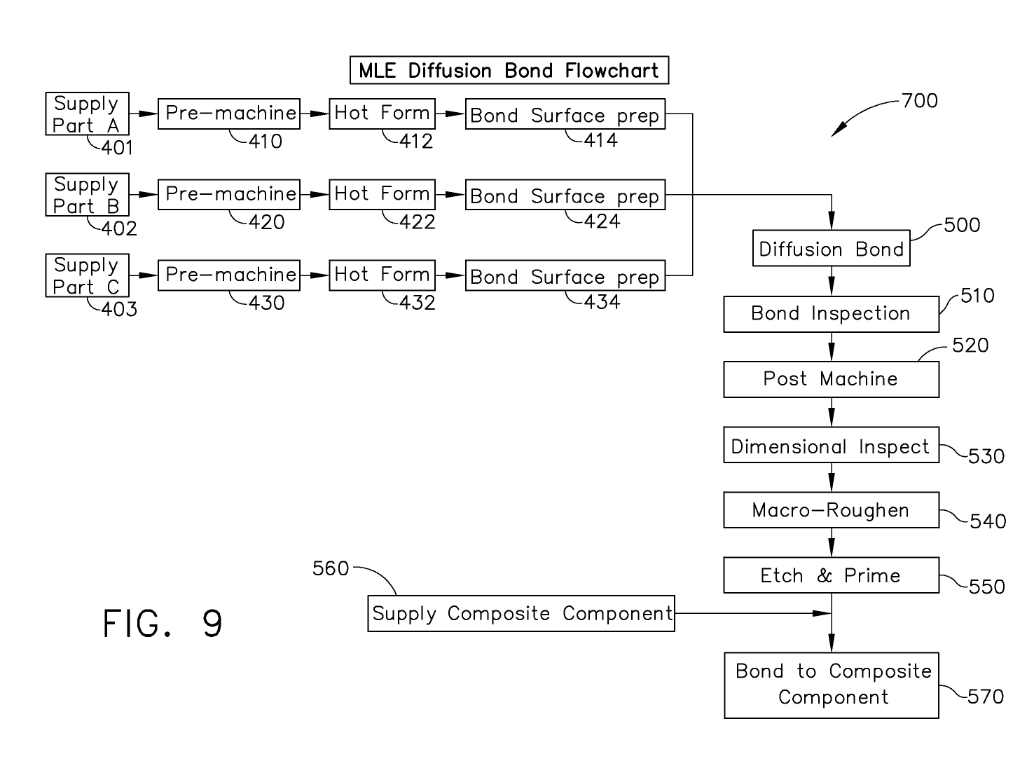

FIG. 9 shows an exemplary method 700 of manufacturing an article such as the blade assembly shown in FIG. 2. The method comprises the steps (401, 402) of supplying Part A and Part B (see FIG. 5). The Parts A and B are pre-machined (steps 410, 420) using known methods to desired geometry. Parts A and B are then hot-formed (steps 412, 422) using known methods to generate desired complex geometries. Bond surfaces (see FIGS. 5-8) are prepared using known methods, such as cleaning (steps 414, 424). A first bond surface 21 on the first part B and a second bond surface 22 on the second part A are prepared. In alternative embodiments (see FIGS. 7 and 8) optional additional parts (such as Part C) may be similarly supplied (403), pre-machined (430), hot formed (432) and prepared (434). In the next step 500, the prepared Parts A and B (and optionally prepared Part C) are bonded. Known bonding methods may be used. In a preferred embodiment of the method 700, diffusion bonding 500 is used to bond the first part (Part B) and second part (Part A) of the metallic sheath at the first and second bond surfaces (see FIGS. 5-8). Optional Part C may be similarly bonded. The bond is then inspected in Step 510 using known inspection methods. The bonded assembly (see, for example, item 186 in FIG. 6) is then machined (step 520, FIG. 9) using known machining methods. For example, the nose portion 160 of the metallic sheath 10 is machined to form the nose contour 187 (see FIG. 6). After machining, a dimensional inspection (530) may be performed.

The exemplary method 700 of manufacturing may further comprise the steps of mounting the metallic sheath 10 on a component, such as a blade to form a blade assembly 114. This can be done by the steps of preparing the metallic sheath 10 for bonding to the blade airfoil 154 by macro-roughening (step 540) a portion of the side-walls using known methods. These portions are etched and primed (step 550) using known methods. In step 560, the composite component, such as, for example, a blade airfoil 154 is supplied. In step 570, the metallic sheath 10 is bonded to the composite component using known methods, such as using adhesives. In alternative embodiments, the above steps may be repeated as needed to bond a plurality of metallic sheaths (such as, for example, items 156, 150 in FIG.2) to the composite component.

In one embodiment described herein, bonding between the metallic sheath side-walls and the nose block (see FIGS. 4-9) is accomplished using diffusion bonding. Diffusion bonding is a solid state process that joins metals by applying heat and a static pressure to achieve intimate contact between the bond surfaces 21, 22. The heat applied is lower than the melting point of the metals being joined. The heat and pressure are maintained, preferably in vacuum, until bonding occurs by solid-state diffusion. In one embodiment disclosed herein, the diffusion bonding may be achieved using temperatures between about 1700 Deg. F. and 1750 Deg. F. for a time period between about 2 hours and 4 hours while the parts are held at pressures between about 150 psi and 500 psi.

Exemplary embodiments of metallic sheaths such as MLE, trailing edge guards, tip caps etc. and methods of manufacturing them are described above in detail. The methods, apparatus, assemblies and systems are not limited to the specific embodiments described herein nor to the specific illustrated gas turbine engines and engine components.

While the invention has been described in terms of various specific embodiments, those skilled in the art will recognize that the invention can be practiced with modification within the spirit and scope of the claims.

What is claimed is

1. A metallic sheath for a mounting on a component, the metallic sheath comprising:
a nose portion extending in a chordwise direction;
a first side-wall extending in the chordwise direction from the nose portion; and
a second side-wall extending in the chordwise direction from the nose portion wherein the second side-wall is bonded to the nose portion such that the nose portion, the first side-wall and the second side-wall form a cavity capable of receiving a portion of the component.

2. A metallic sheath according to claim 1 wherein the nose portion is machined from a nose block.

3. A metallic sheath according to claim 2 wherein a second bonding surface on the second side-wall is bonded to a first bonding surface on the nose block prior to machining.

4. A metallic sheath according to claim 1 wherein a third bonding surface on the first side-wall is bonded to a fourth bonding surface on the nose block.

5. A metallic sheath according to claim 1 wherein the first-side wall and the second side-wall are bonded to a nose block and the nose portion is machined from the nose block.

6. A metallic sheath according to claim 1 wherein the thickness “A” of at least a portion of the first side-wall tapers in the chordwise direction.

7. A metallic sheath according to claim 1 wherein the thickness of at least a portion of the second side-wall tapers in the chordwise direction.

8. A metallic sheath according to claim 1 wherein the second side-wall is bonded to the nose portion using diffusion bonding.

9. A metallic sheath according to claim 8 wherein the first side-wall is bonded to the nose portion using diffusion bonding.

10. A metallic sheath according to claim 1 wherein the metallic sheath extends in a span-wise direction.

11. A composite article comprising:
composite structure having at least one edge; and
a metallic sheath bonded to a portion of the composite structure, wherein the metallic sheath has a first side-wall and a second side-wall, the first and second side-walls extending in a chordwise direction from a nose portion, wherein the second side-wall is bonded to the nose portion such that the nose portion, the first side-wall and the second side-wall form a cavity that receives a portion of the composite structure.

12. A composite article according to claim 11 wherein the composite structure is an airfoil having a pressure side, a suction side, a leading edge and a trailing edge and wherein the airfoil extends in a span-wise direction.

13. A composite article according to claim 12 wherein the metallic sheath is located near at least a portion of the leading edge.

14. A composite article according to claim 12 wherein the metallic sheath is located near at least a portion of the trailing edge of the composite article.

15. A composite article according to claim 12 wherein the metallic sheath is located near a tip of the airfoil located at the span-wise end of the composite article.

16. A composite article according to claim 11 wherein the second side-wall is bonded to the nose portion using diffusion bonding.

17. A composite article according to claim 11 wherein the first side-wall is bonded to the nose portion using diffusion bonding.

18. A method of manufacturing an article comprising the steps of:
pre-machining and hot-forming a first part of a metallic sheath;
pre-machining and hot-forming a second part of the metallic sheath:
preparing a first bond surface on the first part;
preparing a second bond surface on the second part:
diffusion bonding the first part and second part of the metallic sheath at the first and second bond surfaces; and
machining a nose portion of the metallic sheath.

19. A method of manufacturing according to claim 18 further comprising the step of bonding the metallic sheath to a composite component.

20. A method of manufacturing according to claim 19 further comprising the step of bonding a plurality of metallic sheaths to the composite component.
